(19) United States
(12) Patent Application Publication
(10) Pub. No.: US 2015/0363950 A1
(43) Pub. Date: Dec. 17, 2015

(54) FENCE ESTIMATOR WITH INTELLIGENT FENCE DRAWING MODULE

(71) Applicant: FenceSoft LLC, Schererville, IN (US)

(72) Inventor: Adam T. Gilbert, Cedar Lake, IN (US)

(21) Appl. No.: 14/726,839

(22) Filed: Jun. 1, 2015

Related U.S. Application Data
(60) Provisional application No. 62/013,094, filed on Jun. 17, 2014.

(51) Int. Cl. G06T 11/20; G06K 9/52; G06Q 30/02; G06F 3/0484; G06F 3/0488; G06F 17/50; G06T 11/60

(52) U.S. Cl. CPC G06T 11/20; G06F 17/50; G06K 9/52; G06T 11/60; G06F 3/04845; G06F 3/04883; G06Q 30/0283

(57) ABSTRACT

A computing system for estimating a fence project includes technologies to interactively draw a fence with a computing device and automatically calculate a fence estimate based on the fence drawing.

### CROSS REFERENCE TO RELATED APPLICATION

This application claims the benefit of and priority to U.S. Provisional Patent Application Ser. No. 62/013,094, filed Jun. 17, 2014, which is incorporated herein by this reference in its entirety.

### BACKGROUND

Current software products for the fence industry include the Computer Fencing System (CFS) by Software Design Associates, a three-dimensional deck program by Cornerstone Fence and Deck Company, and Fence Space, a web-based fence estimator.

### BRIEF DESCRIPTION OF THE DRAWINGS

This disclosure is illustrated by way of example and not by way of limitation in the accompanying figures. The figures may, alone or in combination, illustrate one or more embodiments of the disclosure. Elements illustrated in the figures are not necessarily drawn to scale. Reference labels may be repeated among the figures to indicate corresponding or analogous elements.

FIG. 1 is a simplified schematic diagram of an environment of at least one embodiment of a fence estimator computing system including an intelligent fence drawing module as disclosed herein;

FIG. 2 is a simplified flow diagram of at least one embodiment of a method by which the computing system of FIG. 1 may generate fence project estimations as disclosed herein;

FIG. 3 is a simplified block diagram of an exemplary computing environment in connection with which at least one embodiment of the system of FIG. 1 may be implemented;

FIG. 4 is an example of a user interface screen for at least one embodiment of the fence materials input module of the computing system of FIG. 1;

FIG. 5 is an example of a user interface screen for at least one embodiment of the fence drawing module of the computing system of FIG. 1;

FIG. 6 is another view of the user interface screen of FIG. 5, reflecting real time updates to the drawing of FIG. 5;

FIG. 7 is another example of a user interface screen for at least one embodiment of the fence drawing module of the computing system of FIG. 1; and

FIG. 8 is an example of a fence project quote that may be generated by at least one embodiment of the fence project estimation module 118.

### DETAILED DESCRIPTION OF THE DRAWINGS

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

Embodiments of a fence estimator computing system 100 are disclosed herein. The illustrative fence estimator computing system 100 enables fence contractors and others to plan, estimate, organize, and sell fence projects using, for example, a web-based service or a mobile device, such as a smart phone or tablet computer, including any web browser accessible by, e.g., personal computers (PCs, including APPLE Macintosh-based products), iOS-based devices, and ANDROID devices.

The system 100 generates a fence project quote directly from a user's drawing “by hand” of the fence project. The system 100 can send the quote directly to a customer and allow the customer to pay for the project online.

In operation, a user of the system 100 draws the desired fence using, e.g., a mouse, stylus, gestures, “taps and swipes” on a touchscreen display of his or her computing device, or any other suitable method of human-computer interaction. Based on the user interaction with the computing device to effectuate the drawing of the fence, the system 100 generates a list of materials and material prices for the drawn fence. The system 100 can also estimate labor costs, store the fence design project in computer memory for later use/access (e.g., for remote access by a contractor in the field), and complete the fence sale online.

Embodiments of the system 100 can be used for residential and/or commercial fence installation projects. Additionally, although herein described in the context of fence projects, aspects of the system 100 are applicable to many other types of projects and industries, including railing, decking, highway guardrails and barriers, utilities installations (electric, gas, water, sewer, cable, telephone, etc.), concrete curbs, sidewalks, low voltage outdoor projects, sprinkler systems, and indoor wiring, piping, plumbing, heating/cooling duct installation projects, and other projects in which elongated sections of material are installed end-to-end.

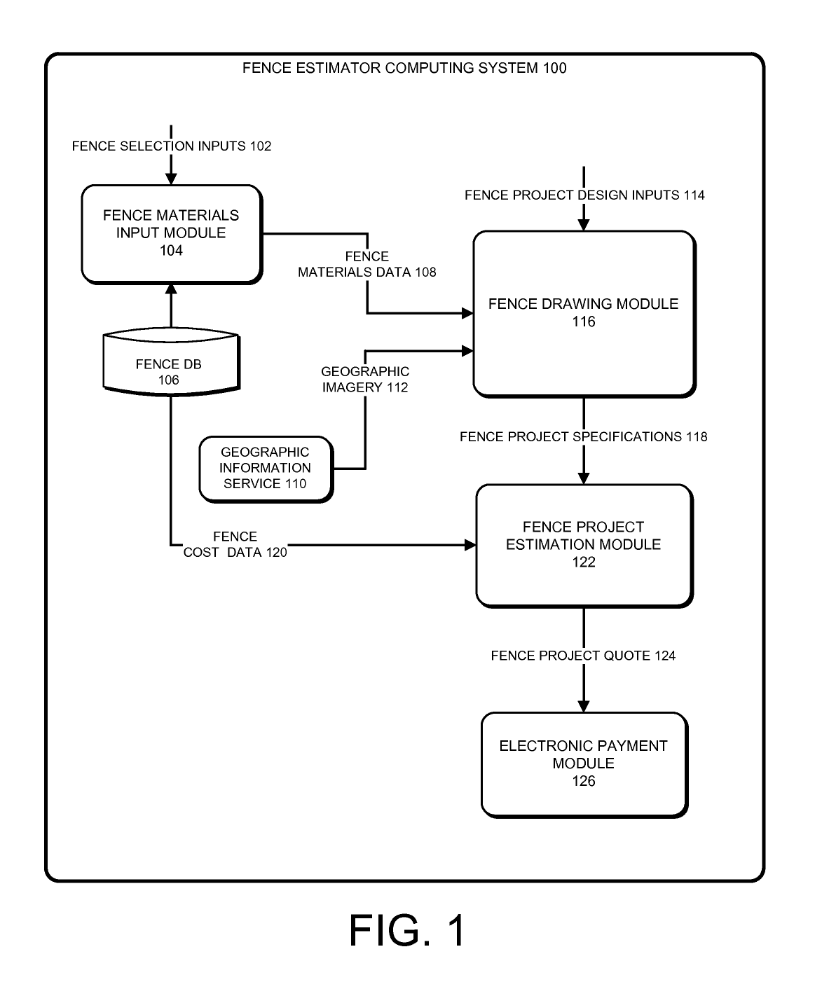

Referring now to FIG. 1, an embodiment of a fence estimator computing system 100 is shown in the context of an environment that may be created during the operation of the system 100 (e.g., a physical and/or virtual execution or “runtime” environment). The system 100 is embodied as a number of machine-readable instructions, modules, data structures and/or other components, which may be implemented as computer hardware, firmware, software, or a combination thereof. The illustrative system 100 includes a fence materials input module 104, a fence database 106, a geographic information service 110 (which may be embodied as an external module or service that is in communication with the system 100, e.g., by a network), a fence drawing module 116, a fence project estimation module 120, and an electronic payment module 124 (which may be embodied as an external module or service that is in communication with the system 100, e.g., by a network).

The illustrative fence database 106 is embodied as a searchable database, table, or other suitable data store, which is populated with fence data, including fence types, materials, components, component types, measurable dimensions (e.g., length, width, weight, etc.), cost information, and installation requirements, including labor. The fence database 106 may be populated by uploading (e.g., by a fence vendor or contractor) product and material information, including photos, descriptions, schematics and other details.

In operation, the system 100 receives one or more fence selection inputs 102 via the fence materials input module 104. The inputs 102 may be data values that are input directly by an end user (e.g., a contractor or end customer) interfacing with the system 100) or received through an automated data communication mechanism (e.g., uploading from a file or database, or a data transfer from another application, an external system or a database). In any event, the inputs 102 indicate a selected fence type, materials, and/or other parameters that are applicable to a particular fence project.

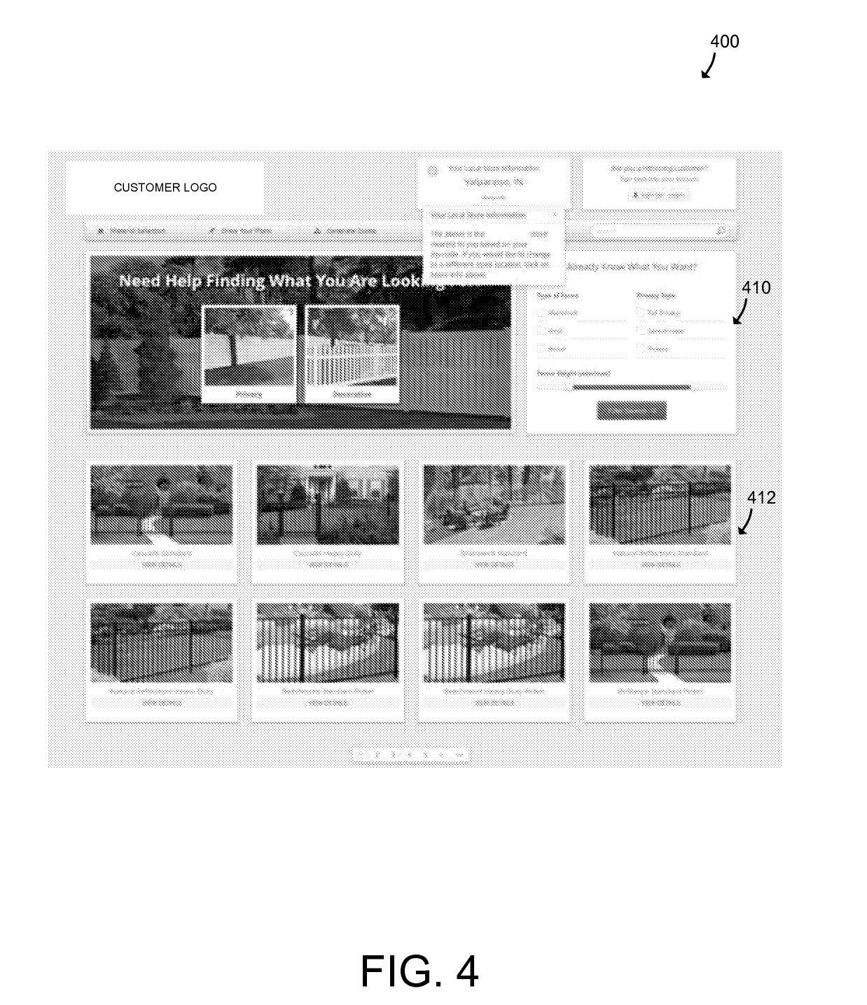

FIG. 4 illustrates an exemplary user interface screen 400, by which the fence selection inputs 102 may be obtained. As shown in FIG. 4, fence materials (e.g., plastic, aluminum, chain link, vinyl, wood, etc.), privacy type (e.g., private, semi-private, picket), and fence height may be selected via graphical user interface controls (e.g., check boxes, slides, etc.) in dialog area 410. Alternatively or in addition, a fence type may be selected by selecting (e.g., clicking with a mouse or tapping a touchscreen) an image corresponding to a desired fence type in dialog area 412.

In response to the fence selection inputs 102, the system 100 retrieves the corresponding fence material details and/or other information from the fence database 106, and supplies fence materials data 108 to the fence drawing module 116. Some examples of fence materials data 108 include data values that indicate the length, width, and/or spacing requirements of the various fence components that are needed to construct a fence of the type selected by the fence selection inputs 102. Some examples of fence components include fence segments (e.g., elongated structural members), various types of fence posts (e.g., vertical structural members designed to support one or more fence segments, including terminal posts and line posts), post caps, gates (e.g., structural members designed to enable ingress/egress to/from a fenced-in area), louvers, and/or others.

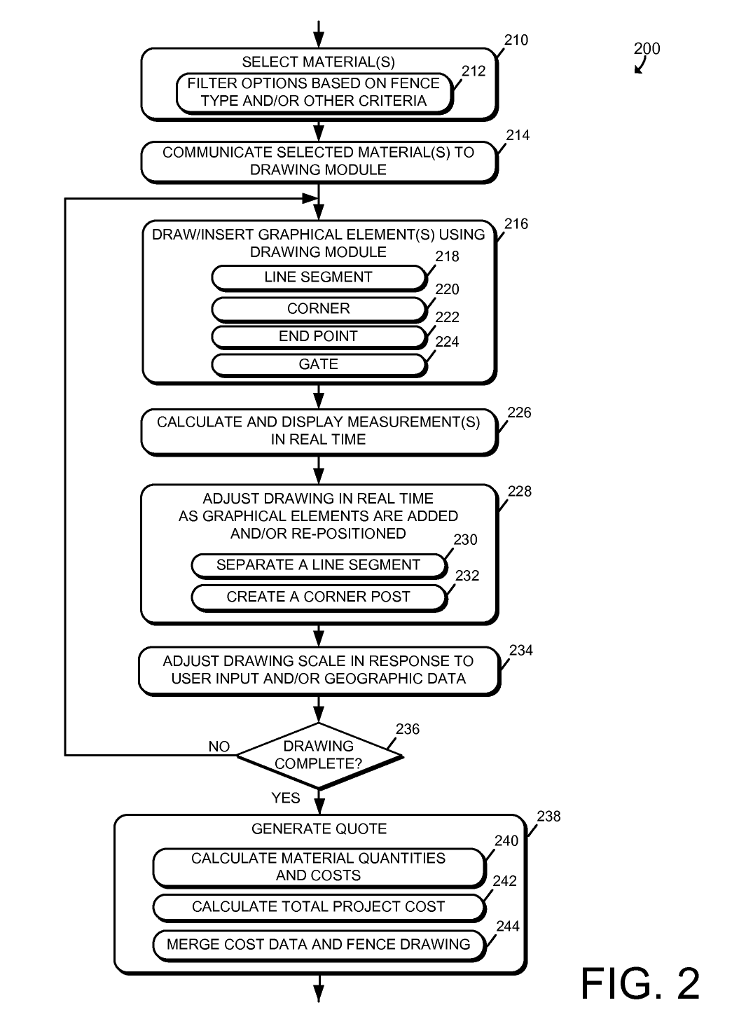

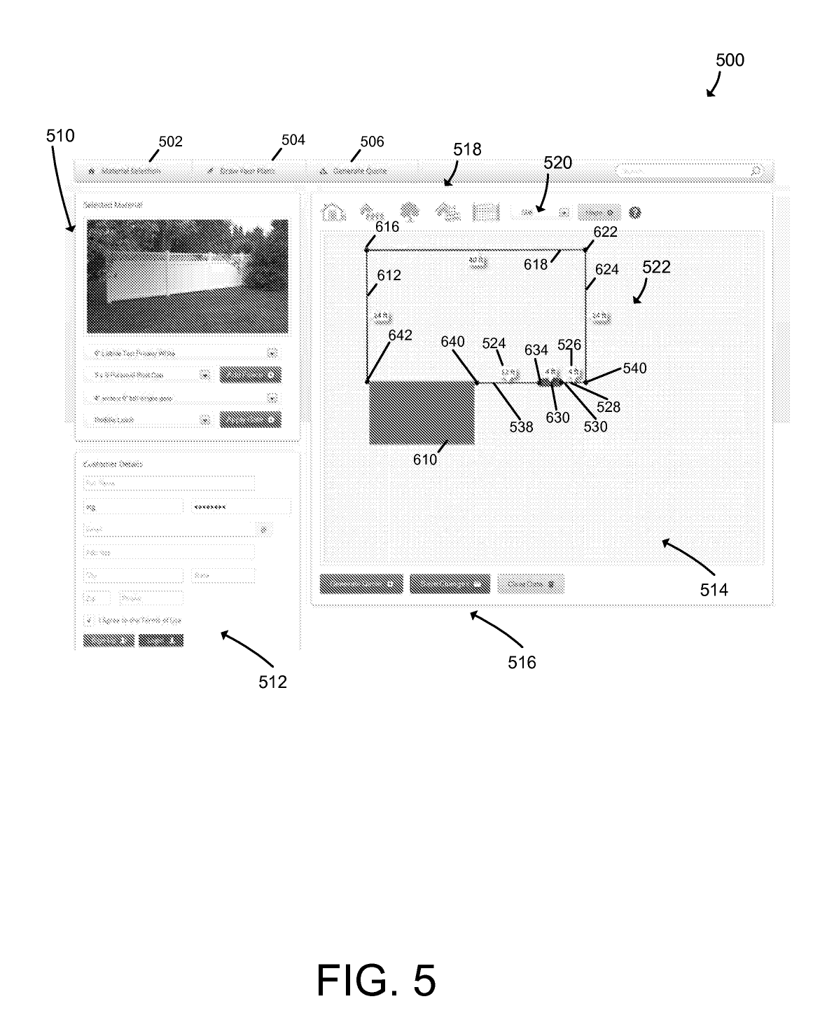

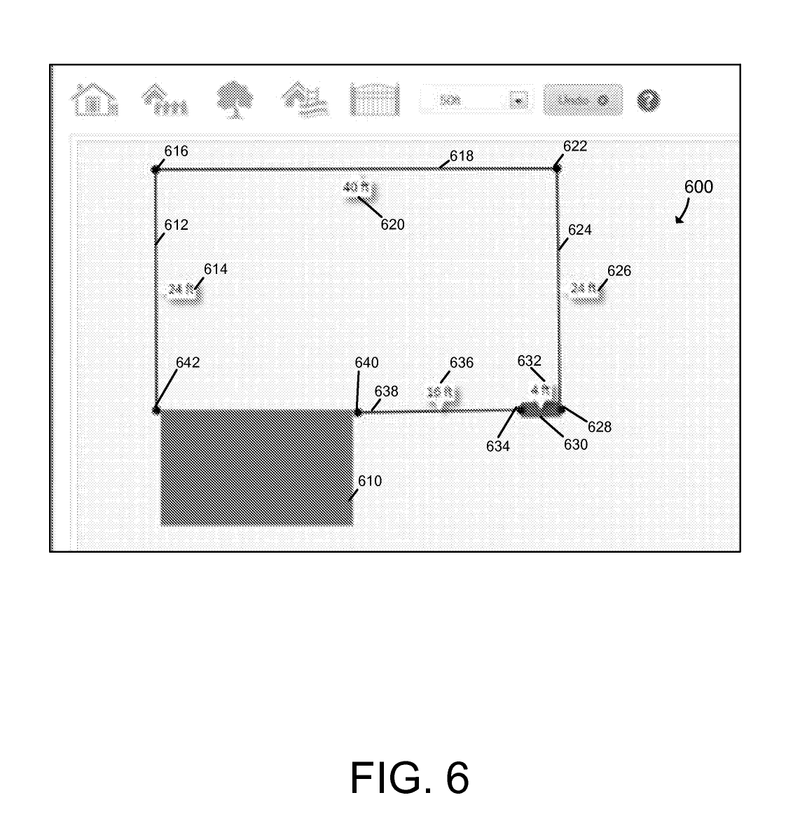

The fence drawing module 116 receives fence project design inputs 114, and in response to the inputs 114, generates a graphical rendering of the design of a fence project. In doing so, the fence drawing module 116 enables an end user to interactively draw and/or insert graphical elements representing components of a fence on a scalable grid interface. Among other things, the fence drawing module 116 allows the end user to move graphical elements (such as gates) “incrementally” along a fence segment (e.g., along a line segment representing a fence or fence segment), “pull” the graphical element (e.g., gate) off of the fence line segment, and re-insert the graphical element (e.g., gate) at different location on the fence line segment. The fence drawing module 116 also allows the end user to d add graphical elements indicating aspects of the surrounding geographic environment to the fence drawing. The fence drawing can be performed using a computer mouse, stylus, or by the user with a finger “drawing” on a touchscreen display, or by another suitable user interface mechanism. The fence drawing module 116 is “intelligent” in that it can utilize the fence materials data 108 along with the scale of the grid interface to automatically calculate fence material requirements “in real time” as the fence drawing is being created. Additionally, the fence drawing module 116 can automatically update the fence material requirements as the user adds or changes aspects of the fence drawing. Illustrative examples of these features are shown in FIGS. 5-6, and also described in more detail below with reference to FIG. 2.

In FIG. 5, an illustrative user interface screen 500 displays portions of the fence materials data 108 corresponding to the fence selection inputs 102, at dialog area 510. For example, an image of the selected fence style, as well as fence components, dimensions and other details, are shown in dialog area 510. Customer information may be displayed in dialog area 512. Selectable controls include a material selection control 502, a “draw your plans” control 504, a “generate quote” control 506, and additional selectable controls 516. A fence drawing 522 is drawn on the scalable grid 514. The current value of the adjustable grid scale is shown at dialog area 520 (e.g., selectable from a pull down list). The grid scale can be set to, for example, 50 feet, 100 feet, 250 feet, or 500 feet, to create a fence drawing having the desired level of detail and based on fence lengths.

Area 518 indicates a number of different graphical icons representing different graphical elements that can be inserted into the drawing 522.

The illustrative drawing 522 includes a number of graphical elements (e.g., lines) 612, 618, 624, 528, 538, each of which represents a fence segment or section of fencing. The drawing 522 also includes a non-fence feature 610, which can be used as a reference point for the construction of the fence. For example, fence posts 640, 642 are connected to opposite ends of the non-fence feature 610. Some examples of non-fence features include houses, buildings, trees, decks, patios, swimming pools, etc. The system 100 enables the addition of graphical elements representing these and/or other non-fence features to the fence drawing 522.

The fence drawing 522 also shows a graphical element 630, which represents a gate. The system 100 allows the user to simply “drop” the gate 630 onto the fence drawing (e.g., onto a fence segment), and automatically updates the drawing to incorporate the gate. In the example of FIG. 5, prior to insertion of the gate 630, the fence segments 528, 538 were connected as a single fence segment. User placement of the gate 630 on the line 528, 538 automatically divided the line 528, 538 into two distinct fence segments (528 and 538, individually), with each individual segment 528, 538 having a length smaller than the total length of the original single line 528, 538. In addition, the system 100 automatically added the fence posts 530, 634 to the drawing 522 in response to the insertion of the gate 630.

The fence drawing 522 shows a number of other graphical elements (e.g., circles or dots) 642, 616, 622, 540, 530, 634, 640, each of which represents a fence post. The system 100 automatically determines the correct type of fence post depending on the number, type, and angle of the graphical elements that are connected by the fence post in the drawing. For example, the system 100 automatically determines that posts 640 and 642 are end posts, while posts 616, 622, and 540 are corner posts, and posts 530, 634 are gate posts. The system 100 automatically updates the fence project specifications 118 to reflect the correct post types. Moreover, with the insertion of the gate 630 on the line 528, 538, the system 100 automatically updates the fence project specifications 118 to include two fence segments of the appropriate length as opposed to a single fence segment.

When fence segments are added to the drawing 522, the system 100 automatically calculates the appropriate length of each segment, and displays the length in real world measurement units (e.g., feet) on the drawing 522. For example, in the drawing 522, the system 100 has calculated the length of the fence segment 612 to be 24 feet, based on the length of the drawn line 612. To do this, the system 100 correlates the length of the line 612 with the current scale 520 of the grid, which is mapped to a physical measurement unit. As an example, if the line 612 has a “virtual” measurement of X pixels on the drawing 522, the system 100 executes a mathematical conversion function to obtain the corresponding real-world physical measurement (e.g., Y feet). In the illustrative embodiments, the system 100 is able to draw fence segments and calculate corresponding physical measurements in increments that are in the range of about one foot or less. For example, each grid block on the grid 514 may represent one square foot.

FIG. 6 illustrates a new iteration 600 of the drawing 522, in which the user has moved the gate 630 incrementally (e.g., in 1-foot increments) from the position shown in FIG. 5 to the position shown in FIG. 6. To do this, the system 100 allows the user to simply drag the gate 630 along the fence line, e.g., tracing on top of the fence line, to change its position on the fence line, and the system 100 automatically updates the fence line to incorporate the new gate position. Thus, whereas in the drawing 522, the fence line on which the fence 630 is inserted included two fence segments 538, 528; now, in FIG. 6, with the gate 630 moved to the corner position, the same fence line only includes one fence segment, 638. Whereas in FIG. 5, the three elements, fence segment 538 (12 feet long), gate 630 (4 feet long), and fence segment 528 (4 feet long) make up a total of 20 feet in length; in FIG. 6, only two elements, fence segment 636 (16 feet long) and gate 630 (4 feet long) make up the total length of 20 feet (e.g., by removing the segment 528 and adding length to the segment 538). In addition, with the gate 630 now positioned at a corner of the fence, the system 100 automatically updates the corner post 540 shown in FIG. 5 to a gate post 628 in FIG. 6 and updates the fence project specifications 118 to reflect the change in post type.

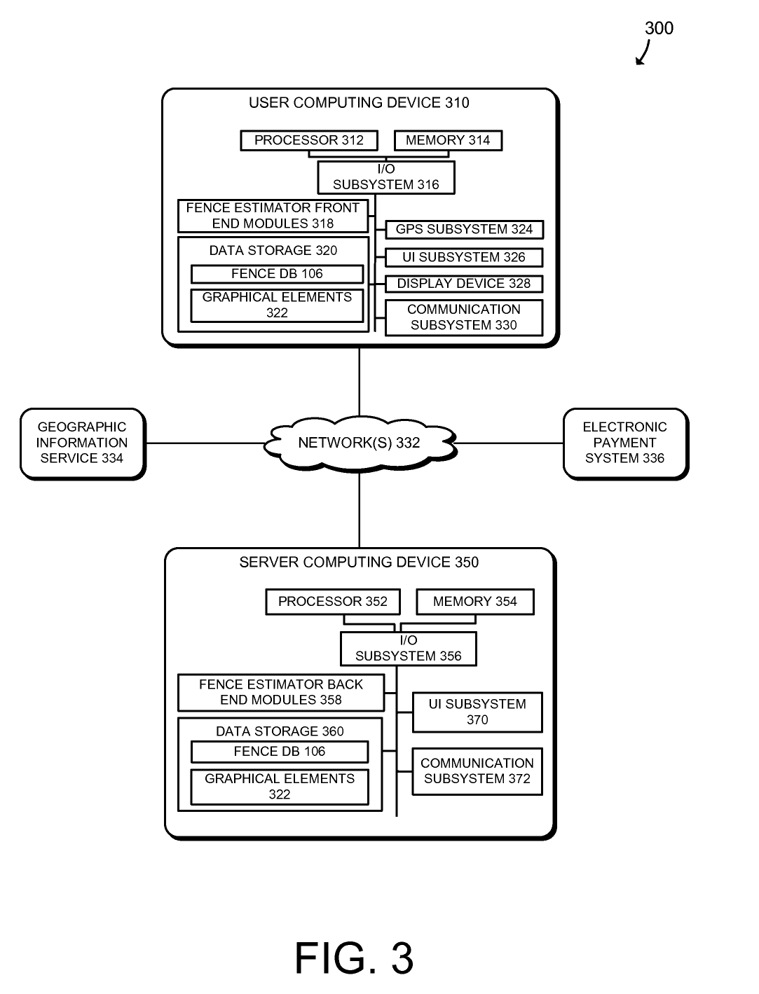

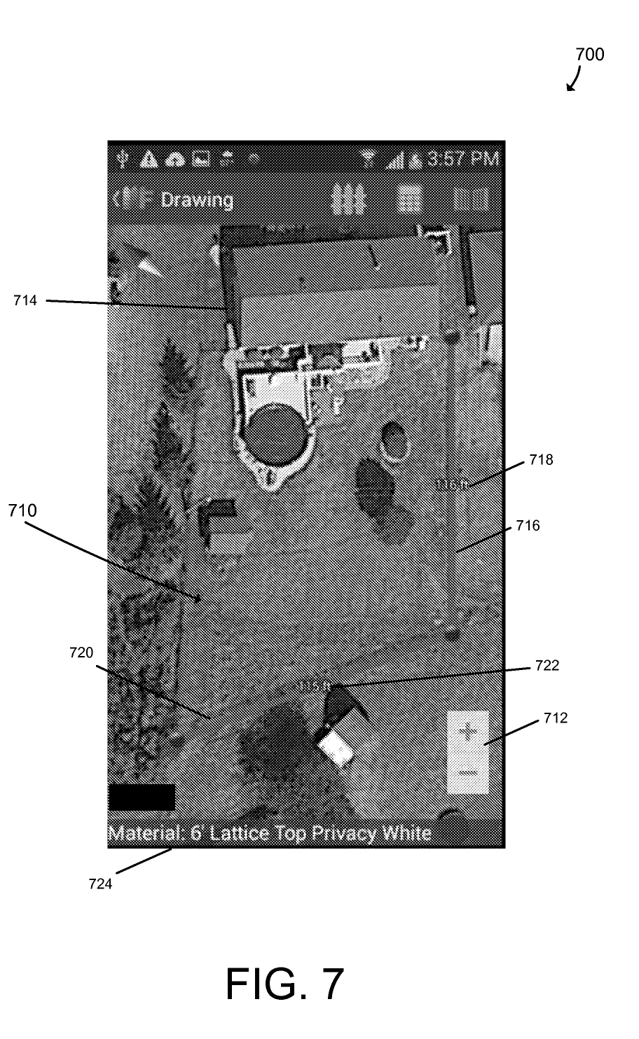

In some embodiments, the fence drawing module 116 receives geographic imagery 112 from a geographic information service 110, which corresponds to a geographic location at which a fence project is to be installed. In these embodiments, the system 100 determines the actual geographic coordinates of the fence installation location using, e.g., a Global Positioning System (GPS) subsystem 324, which may be integrated in a mobile computing device running the fence estimator application (e.g., the fence drawing module 118) as shown in FIG. 3. As shown in FIG. 7, the fence drawing module 116 enables the fence design to be overlaid on the geographic imagery. The illustrative user interface display screen 700 may be displayed on a touchscreen display of a mobile device. The screen 700 displays the geographic imagery 710, which, in the illustrative embodiment, is a satellite view of a fence installation location. The system 100 provides controls 712, which allow the user to zoom in or zoom out to change the scale of the imagery 710 and likewise, the drawing scale. Shown in the imagery 710 is a residence 714. Using a stylus or one's finger, for example, the fence segments 716 and 720 are drawn on the display of the imagery 710. The system 100 automatically calculates the length of each segment and displays it on the fence drawing, on the corresponding fence segment (e.g., length measurement 718 indicates the physical real world length (e.g., in feet) of the fence segment 716, and similarly, the length measurement 722 indicates the length of the fence segment 720. The display 700 also indicates the fence material selected for the fence drawing, at 724. If the user were to select a different fence material, the system 100 would automatically update the fence project specifications 118 to reflect the parameters associated with the new fence material.

Referring back to FIG. 1, the fence drawing module 116 determines and outputs the fence project specifications 118, which include the physical measurements (e.g., lengths) of all fence segments in the drawing of the fence project, as calculated by the fence drawing module 116, and quantities and measurements of the other fence components shown in the fence drawing (e.g., gates, posts, etc.).

The fence project estimation module 122 utilizes fence cost data 120 obtained from the fence database 106 to calculate the unit cost for each fence component of the fence project specifications 118, and a total cost for the entire fence project represented by the drawing created by the fence drawing module 116. To do so, the fence project estimation module 122 executes price calculation algorithms that utilize the precise measuring and analytical data that is obtained by the system 100 directly from the drawing grid (e.g., the grid 514). As discussed above, the grid 514 and its associated scale 520 are defined and correlated with real world measurement units to provide accurate length and material quantity calculations. The mapping criteria for mapping grid length to physical real world unit measurements, and for mapping the size of the graphical elements in the fence drawing to real world physical quantities, may be obtained through an initialization process in which such mappings are established manually and stored in a portion of the fenced database 106.

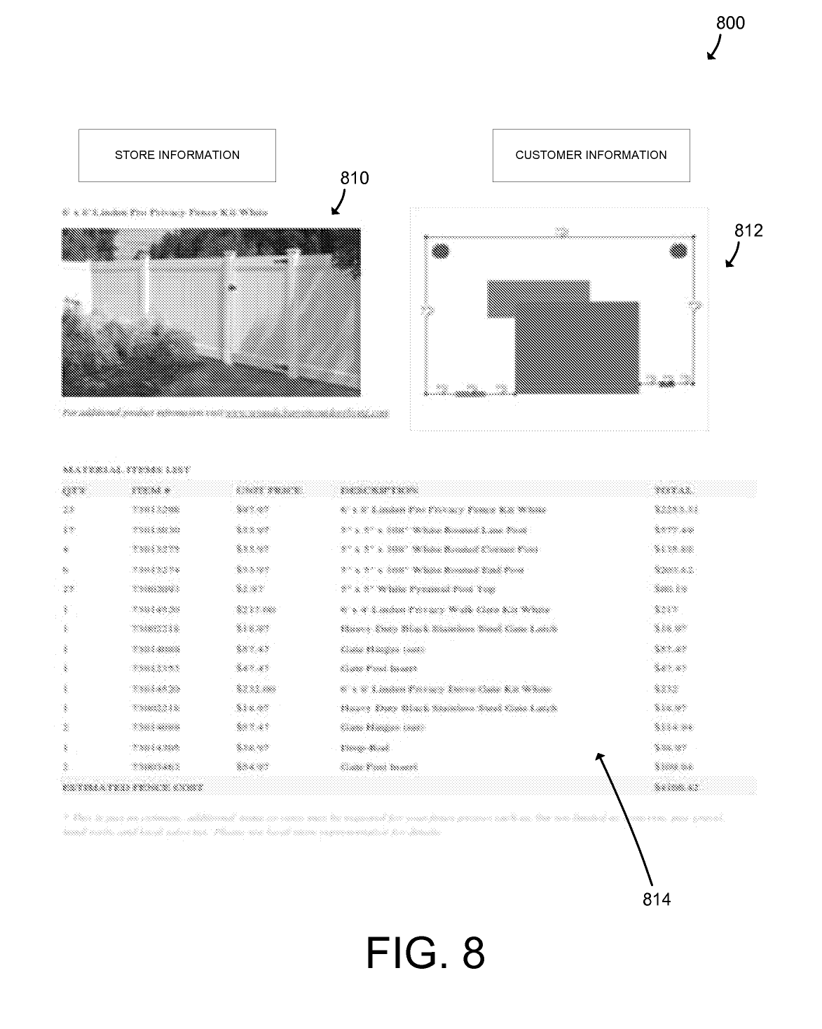

The fence project estimation module 122 assembles the fence project materials and cost information, and prepares a fence project quote 124 that includes the materials and cost information, and also includes a copy of the fence drawing prepared by the fence drawing module 116. An illustrative example of a fence quote that may be produced by the fence project estimation module 122 is shown in FIG. 8. The quote 800 includes an image of the selected fence material 810, a copy of the fence drawing 812, and a detailed listing 814 of materials, quantities, unit prices, total prices for each material, and total project cost. The system 100 may send the fence project quote 124 to one or more external systems, such as customer or contractor computing systems, and/or to an electronic payment module 126. The electronic payment module 126 may be implemented as an external system to which the system 100 connects over a network, in some embodiments (e.g., authorize.net or a similar web-based service).

Referring now to FIG. 2, an example of a method 200 by which the system 100 may provide fence project estimates is shown. The method 200 may be embodied as computerized programs, routines, logic and/or instructions executed by the computing system 100. For example, portions of the method 200 may be executed by the fence drawing module 116 and/or the fence project estimation module 122.

At block 210, the system 100 selects the fence materials (e.g., in response to user input). In doing so, the system 212 may filter the fence material options based on the type of fence selected and/or other criteria (e.g., keyword or topic searching). At block 214, the system 200 communicates the selected materials to the fence drawing module 116 (e.g., as fence materials data 108). It should be noted that the system 100 allows for the selection of multiple different types of fence material in a single fence project, in some embodiments. Thus, different fence segments may comprise different fence materials, and the system 100 can accurately generate a quote for the fence project nonetheless.

At blocks 216, 226, 228, 234, the system 100 conducts the interactive, iterative fence drawing process. At block 216, the system 100 draws and/or inserts one or more graphical element on the fence drawing grid (e.g. on a touchscreen display device). Such graphical elements may include icons or other graphics that represent fence segments (line segments) 218, corners 220 (e.g. corner posts), end points 222 (e.g. end posts), and gates 224. At block 226, the system 100 calculates and displays the fence component measurements in real time. For example, as shown in FIGS. 5-6, the length of each fence segment, and the length of the gate 630, are displayed on the fence drawing. Each length measurement is displayed interactively in response to the graphical element being drawn or inserted into the fence drawing. At block 228, the system 100 adjusts the fence drawing in real time, automatically, as graphical elements are added to the drawing, re-sized, or re-positioned. For example, the system 100 may separate a line segment into two line segments (e.g. in response to insertion of a gate) at 230, or create a corner post (e.g., in response to the connecting of two line segments at a ninety degree angle, or another angle that forms a corner, e.g., is less than 180 degrees), at 232. At block 234, the system 100 adjusts the drawing scale in response to user input and/or geographic data. For instance, as the user zooms in or out on satellite imagery, the system 100 responsively adjusts the drawing scale.

In more detail, embodiments of the drawing grid interface of the system 100 allows for per-foot (or other discrete measurement unit) lines to be drawn by the end user (e.g., by hand) and gate icons to be dragged onto or on the ends of existing lines. Snap-to-functionality is used in some embodiments to round points and lengths to the nearest foot (or other discrete measurement unit). Also, user interactions that drag ends of lines to touch one another (sharing the same footage point) can snap-to and become a “corner post.” Footage markers show the length of each segment of line. Additionally, when two fence lines are connected, the system 100 determines the angle created by the connection of the two lines. If the angle is less than 180 degrees (indicating, e.g., that the fence segments are not collinear), the system 100 treats the connection as a corner and updates the corresponding fence material to, for example, include a corner post.

The fence line drawing functionality can be enabled by a single tap on, e.g., a ‘+Line’ button on a touchscreen user interface. When a line is selected, a double tap on any given point on the drawing grid can start a line and a single tap on any given point can end the line (e.g., point A-B). This creates a new line segment with A and B end points. Angles of lines and coordinates are extracted from the grid and stored to be used in the estimating algorithm. A selected gate may be added to any point on the grid using a single-tap. Double-tapping an existing end-point/corner-point on a line can allow the user to adjust position of the line(s) (length and position of point(s)). Double-tapping an existing gate can allow a user to reposition the gate using an additional single-tap elsewhere on the grid. Lines can react in real-time to gate insertions, changes in gate positions, and other line positions, automatically as adjustments are made.

At block 236, the system 100 determines whether the fence drawing is complete. To do this, the system 100 may determine whether a “generate quote” button has been tapped. If the system determines that the drawing is not complete (e.g., the absence of any activation of a “quote” button), the system 100 returns to block 216 and continues the interactive fence drawing. If the system 100 determines that the fence drawing is complete, the system 100 proceeds to block 238 and generates the fence project quote 124. To do this, the system 100 may calculate the fence material quantities and costs at 240, calculate the total project cost at 242, and merge the cost data and fence drawing onto a single quote document, at 244.

Referring now to FIG. 3, a simplified block diagram of an embodiment 300 of the fence estimator computing system 100 is shown. While the illustrative embodiment 300 is shown as involving multiple components and devices, it should be understood that the fence estimator computing system 100 may constitute a single computing device, alone or in combination with other devices. The embodiment 300 includes a user computing device 310, which embodies features and functionality of a “client-side” or “front end” portion 318 of the fence estimator modules depicted in FIG. 1, and a server computing device 350, which embodies features and functionality of a “server-side” or “back end” portion 358 of the fence estimator modules depicted in FIG. 1. The embodiment 300 includes a geographic information service 334 and an electronic payment system 336, each of which may embody the functionality of the corresponding modules 110, 126, described above. Each or any of the computing devices/systems 310, 350, 334, 336 may be in communication with one another via one or more networks 332.

The fence estimator computing system 100 or portions thereof may be distributed across multiple computing devices that are connected to the network(s) 330 as shown. In other embodiments, however, the system 100 may be located entirely on, for example, the computing device 310. In some embodiments, portions of the fence estimator system 100 may be incorporated into other systems or computer applications. Such applications or systems may include, for example, commercial off the shelf (COTS) computer applications. As used herein, “application” or “computer application” may refer to, among other things, any type of computer program or group of computer programs, whether implemented in software, hardware, or a combination thereof, and includes self-contained, vertical, and/or shrink-wrapped software applications, distributed and cloud-based applications, and/or others. Portions of a computer application may be embodied as firmware, as one or more components of an operating system, a runtime library, an application programming interface (API), as a self-contained software application, or as a component of another software application, for example.

The illustrative user computing device 310 includes at least one processor 312 (e.g. a microprocessor, microcontroller, digital signal processor, etc.), memory 314, and an input/output (I/O) subsystem 316. The computing device 310 may be embodied as any type of computing device capable of performing the functions described herein, such as a personal computer (e.g., desktop, laptop, tablet, smart phone, body-mounted device, wearable device, etc.), a server, an enterprise computer system, a network of computers, a combination of computers and other electronic devices, or other electronic devices. Although not specifically shown, it should be understood that the I/O subsystem 316 typically includes, among other things, an I/O controller, a memory controller, and one or more I/O ports. The processor 312 and the I/O subsystem 316 are communicatively coupled to the memory 314. The memory 314 may be embodied as any type of suitable computer memory device (e.g., volatile memory such as various forms of random access memory).

The I/O subsystem 316 is communicatively coupled to a number of hardware and/or software components, including the modules 318, a data storage device 320, the GPS subsystem 324 (which includes one or more location/orientation sensor(s)), a user interface subsystem 326, a display device 328, and a communication subsystem 330.

The user interface subsystem 326 includes one or more user input devices (e.g., a touchscreen, keyboard, virtual keypad, microphone, etc.) and one or more output devices (e.g., speakers, displays, LEDs, etc.). The user input devices may include, for example, a motion sensor, a kinetic sensor and/or other gesture-detecting device, an eye-tracking sensor, and/or other devices that are capable of detecting human interactions with a computing device.

The storage media 320 may include one or more hard drives or other suitable data storage devices (e.g., flash memory, memory cards, memory sticks, and/or others). In some embodiments, portions of the modules 318, the fence database 106, the graphical elements 322 (which may include any or all of the graphical elements mentioned above) and/or other data, reside at least temporarily in the storage media 320. Portions of the fence estimator modules 318, the fence database 106, the graphical elements 322, and/or other data may be copied to the memory 314 during operation of the computing device 310, for faster processing or other reasons.

The communication subsystem 330 communicatively couples the user computing device 310 to one or more other devices, systems, or communication networks, e.g., a local area network, wide area network, personal cloud, enterprise cloud, public cloud, and/or the Internet, for example. Accordingly, the communication subsystem 330 may include one or more wired or wireless network interface software, firmware, or hardware, for example, as may be needed pursuant to the specifications and/or design of the particular embodiment of the system 300.

The geographic information service 334, the electronic payment system 336, and the server computing device 350 each may be embodied as any suitable type of computing device capable of performing the functions described herein, such as any of the aforementioned types of devices or other electronic devices. For example, in some embodiments, the server computing device 350 may include one or more server computers including storage media 360, which may be used to store portions of the fence estimator modules 358, the fence database 106, the graphical elements 322, and/or other data. The illustrative server computing device 350 also includes a user interface subsystem 370, and a communication subsystem 372. In general, components of the server computing device 350 having similar names to components of the computing device 310 described above may be embodied similarly. Further, each of the computing devices 350, 334, 336 may include components similar to those described above in connection with the user computing device 310. The computing system 300 may include other components, sub-components, and devices not illustrated in FIG. 3 for clarity of the description. In general, the components of the computing system 300 are communicatively coupled as shown in FIG. 3 by signal paths, which may be embodied as any type of wired or wireless signal paths capable of facilitating communication between the respective devices and components.

Illustrative examples of the technologies disclosed herein are provided in the examples set forth below. An embodiment of the technologies may include any one or more, and any combination of, the examples described below and/or other features described in this disclosure.

In an example 1, a computing system for estimating a requirement of a fence project includes a plurality of processor-executable modules embodied in one or more machine accessible storage media, the processor-executable modules including a fence drawing module to, in response to user interaction with the computing system: draw, on a display device, a graphical element representing a fence; determine a virtual measurement of a dimension of the drawn graphical element according to a virtual unit of measurement; and calculate, based on the virtual measurement, a physical measurement of the fence; and in an automated fashion, update the physical measurement in response to a change in the drawing of the graphical element; and a fence estimator module to calculate a cost of the fence based on the drawing of the fence.

An example 2 includes the subject matter of example 1, wherein the fence drawing module is to determine a fence type associated with the graphical element and calculate the physical measurement based on the virtual measurement and the fence type. An example 3 includes the subject matter of example 1 or example 2, wherein the fence drawing module is to draw a second graphical element on the display device, connect the second graphical element with a portion of the graphical element, and automatically update the physical measurement of the fence in response to the connection of the second graphical element with the first graphical element. An example 4 includes the subject matter of example 3, wherein the fence drawing module is to change the location of the second graphical element with respect to the first graphical element, and automatically update the physical measurement of the fence in response to the re-locating of the second graphical element with respect to the first graphical element. An example 5 includes the subject matter of example 4, wherein the graphical element represents a fence segment, the second graphical element represents a gate to be connected to the fence, and the fence drawing module is to automatically update the physical measurement of the fence in response to the re-locating of the gate in relation to the fence segment. An example 6 includes the subject matter of example 3, wherein the fence drawing module is to change a third graphical element to a different graphical element in response to the connection of the second graphical element with the graphical element. An example 7 includes the subject matter of example claim 6, wherein the graphical element represents a segment of the fence, the second graphical element represents a gate to be connected to the fence, the third graphical element represents a post to connect two segments of the fence, and the fence drawing module is to automatically change the post to a different post type in response to the connection of the gate to the fence. An example 8 includes the subject matter of any of the preceding examples, wherein the fence estimator module is to output a quote, wherein the quote displays the drawing of the fence. An example 9 includes the subject matter of any of the preceding examples, wherein the fence drawing module is to receive imagery of a geographic location and overlay the fence drawing on the imagery of the geographic location. An example 10 includes the subject matter of any of the preceding examples, wherein at least a portion of the fence drawing module is embodied in a mobile computing device. An example 11 includes the subject matter of any of the preceding examples, wherein the user interaction with the computing device comprises a physical touching of the display device, and the fence drawing module draws the graphical element in response to the physical touching of the display device.

In an example 12, a fence estimator computing system includes a fence drawing module that enables an end user to create a drawing representing a design of a fence project, and formulates a quote for the fence project based on the user-created drawing, where the fence drawing module provides one or more of the following features and/or functionality, in response to user input: draws graphical elements representing fence components on a scalable grid; draws lines representing fence segments; connects lines representing two fence segments; inserts graphical elements representing fence posts in response to the connection of two lines; detects corners created by the connection of two lines, determines the angle created by the corner, and determines the appropriate type of fence post to connect the two lines based on the angle of the corner; incrementally increases or decreases the length of fence segments according to an adjustable scale, including in increments of 1 foot or less; inserts a graphical element representing a gate on a fence line; moves the gate element to change the position of the gate element incrementally along the fence line, including in increments of 1 foot or less; adjusts other fence components in response to insertion and/or movement of the gate element, including changing the type of fence post and changing the length and/or number of fence segments on the fence line; removes fence elements from the fence drawing, including removing the gate element and automatically updating the fence design to account for the removal of the gate element (e.g., by connecting previously-separated fence segments, updating fence post types); re-positions fence elements on the fence drawing, for example, by removing a fence element from one location on the fence drawing and inserting the fence element at another location on the fence drawing, or by moving a fence element incrementally along a fence line or on the drawing grid, and automatically updating the fence design to account for the re-positioning of the fence element; adds one or more non-fence features to the fence drawing, such as buildings, trees, and other structures, and draws the fence in relation to the non-fence features; and overlaying the fence drawing on imagery of a real-world geographic location of a fence project, such as satellite imagery.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, blocks, and the like are referred to as such for ease of discussion, and are not intended to imply that any specific implementation details are required. For example, any of the described modules and/or data structures may be combined or divided into sub-modules, sub-processes or other units of computer code or data as may be required by a particular design or implementation. In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure. This disclosure is to be considered as exemplary and not restrictive in character, and all changes and modifications that come within the spirit of the disclosure are desired to be protected.

1. A computing system for estimating a requirement of a fence project, the computing system comprising a plurality of processor-executable modules embodied in one or more machine accessible storage media, the processor-executable modules comprising:
a fence drawing module to, in response to user interaction with the computing system:
draw, on a display device, a graphical element representing a fence;
determine a virtual measurement of a dimension of the drawn graphical element according to a virtual unit of measurement; and
calculate, based on the virtual measurement, a physical measurement of the fence; and
in an automated fashion, update the physical measurement in response to a change in the drawing of the graphical element; and
a fence estimator module to calculate a cost of the fence based on the drawing of the fence.

2. The computing system of claim 1, wherein the fence drawing module is to determine a fence type associated with the graphical element and calculate the physical measurement based on the virtual measurement and the fence type.

3. The computing system of claim 1, wherein the fence drawing module is to draw a second graphical element on the display device, connect the second graphical element with a portion of the graphical element, and automatically update the physical measurement of the fence in response to the connection of the second graphical element with the first graphical element.

4. The computing system of claim 3, wherein the fence drawing module is to change the location of the second graphical element with respect to the first graphical element, and automatically update the physical measurement of the fence in response to the re-locating of the second graphical element with respect to the first graphical element.

5. The computing system of claim 4, wherein the graphical element represents a fence segment, the second graphical element represents a gate to be connected to the fence, and the fence drawing module is to automatically update the physical measurement of the fence in response to the re-locating of the gate in relation to the fence segment.

6. The computing system of claim 3, wherein the fence drawing module is to change a third graphical element to a different graphical element in response to the connection of the second graphical element with the graphical element.

7. The computing system of claim 6, wherein the graphical element represents a segment of the fence, the second graphical element represents a gate to be connected to the fence, the third graphical element represents a post to connect two segments of the fence, and the fence drawing module is to automatically change the post to a different post type in response to the connection of the gate to the fence.

8. The computing system of claim 1, wherein the fence estimator module is to output a quote, wherein the quote displays the drawing of the fence.

9. The computing system of claim 1, wherein the fence drawing module is to receive imagery of a geographic location and overlay the fence drawing on the imagery of the geographic location.

10. The computing system of claim 1, wherein at least a portion of the fence drawing module is embodied in a mobile computing device.

11. The computing system of claim 1, wherein the user interaction with the computing device comprises a physical touching of the display device, and the fence drawing module draws the graphical element in response to the physical touching of the display device.

12. A fence estimator computing system including a fence drawing module that enables an end user to create a drawing representing a design of a fence project, and formulates a quote for the fence project based on the user-created drawing, where the fence drawing module provides one or more of the following features and/or functionality, in response to user input:
draws graphical elements representing fence components on a scalable grid;
draws lines representing fence segments;
connects lines representing two fence segments;
inserts graphical elements representing fence posts in response to the connection of two lines;
detects corners created by the connection of two lines, determines the angle created by the corner, and determines the appropriate type of fence post to connect the two lines based on the angle of the corner;
incrementally increases or decreases the length of fence segments according to an adjustable scale, including in increments of 1 foot or less;
inserts a graphical element representing a gate on a fence line;
moves the gate element to change the position of the gate element incrementally along the fence line, including in increments of 1 foot or less;
adjusts other fence components in response to insertion and/or movement of the gate element, including changing the type of fence post and changing the length and/or number of fence segments on the fence line;
removes fence elements from the fence drawing, including removing the gate element and automatically updating the fence design to account for the removal of the gate element (e.g., by connecting previously-separated fence segments, updating fence post types);
re-positions fence elements on the fence drawing, for example, by removing a fence element from one location on the fence drawing and inserting the fence element at another location on the fence drawing, or by moving a fence element incrementally along a fence line or on the drawing grid, and automatically updating the fence design to account for the re-positioning of the fence element;
adds one or more non-fence features to the fence drawing, such as buildings, trees, and other structures, and draws the fence in relation to the non-fence features; and
overlaying the fence drawing on imagery of a real-world geographic location of a fence project, such as satellite imagery.
